(19) United States
(12) Patent Application Publication
(10) Pub. No.: US 2020/0143700 A1
(43) Pub. Date: May 7, 2020

(54) UAV QUALITY CERTIFICATION TESTING SYSTEM USING UAV SIMULATOR, AND METHOD THEREOF

(71) Applicant: Electronics and Telecommunications Research Institute, Daejeon (KR)

(72) Inventors: Yoo La HWANG, Daejeon (KR); Byoung Sun LEE, Daejeon (KR); Soo Jeon LEE, Daejeon (KR)

(73) Assignee: Electronics and Telecommunications Research Institute, Daejeon (KR)

(21) Appl. No.: 16/674,841

(22) Filed: Nov. 5, 2019

(30) Foreign Application Priority Data
Nov. 5, 2018 (KR) 10-2018-0134599
Nov. 4, 2019 (KR) 10-2019-0139430

(51) Int. Cl. G09B 9/48; G09B 9/24; G05D 1/00; G09B 19/16

(52) U.S. Cl. CPC G09B 9/48; G09B 9/24; G09B 19/165; G05D 1/0022; G05D 1/0033; G05D 1/0044

(57) ABSTRACT

Disclosed is a UAV quality certification system. The UAV quality certification system according to an embodiment of the present disclosure may include: a virtual UAV configuring unit determining information on hardware devices included in a UAV, and configuring a virtual UAV; a UAV simulator performing simulation for the virtual UAV; a UAV flight learning unit controlling learning for a UAV flight learning model that receives the information on hardware devices included in the UAV as an input, and outputs a result of the simulation; and a quality evaluation unit performing quality evaluation on at least one target included in the UAV by using the UAV flight learning model.

### CROSS REFERENCE TO RELATED APPLICATION

The present application claims priority to Korean Patent Application No. 10-2018-0134599 and 10-2019-0139430, filed Nov. 5, 2018 and Nov. 4, 2019 respectively, the entire contents of which is incorporated herein for all purposes by this reference.

### BACKGROUND OF THE INVENTION

### Field of the Invention

The present disclosure relates to a computing system for a UAV. More particularly, the present disclosure relates to a simulation apparatus for an unmanned aerial vehicle, and an operational method therefor.

### Description of the Related Art

In general, an unmanned aerial vehicle (UAV) refers to an aerial vehicle in which people do not board. In other words, a UAV is an autonomous flying vehicle that recognizes and determines a surrounding environment (obstacles, airline, etc.) according to a program input in advance without a pilot or by the aircraft itself. Recently, a UAV is used for various purposes such as weather observation, terrain exploration, reconnaissance, surveillance, etc., and has been developed in various sizes and forms as a platform where posture and position thereof can be automatically controlled by an embedded flight control program without people on board, and can be moved to a desired position by a command of a remote control station.

In order to successfully develop such a UAV, an excellent flight control system capable of replacing a pilot has to be established, and flight control software with high reliability has to be designed for a program that is will be embedded in the established flight control system.

Although flight control software has been designed, operation of the software in conjunction with hardware of a UAV is difficult to succeed at a time, and a process of verifying the reliability of the designed flight control software has to be preceded. For the same, conventionally, the designed flight control software is directly embedded in a flight control system and observed while operating a UAV. However, practically, since the UAV is expensive, when the UAV falls due to defects such as flight control software, and is damaged during a test flight for reliability verification, large economic loss occurs.

### SUMMARY OF THE INVENTION

According to the above, a system is required where flight status data of an actual UAV is input to a flight control system, and integrity of the flight control software is determined by verifying that intended control results are obtained through flight simulation that simulates the UAV.

An objective of the present disclosure is to provide a UAV quality certification system capable of efficiently and accurately performing quality certification for the UAV.

Another objective of the present disclosure is to provide a UAV quality certification system capable of performing simulation for the UAV by reflecting various environments where the UAV is operated, and performing learning for a UAV flight learning model by using data generated in the simulation.

Still another objective of the present disclosure is to a UAV quality certification system capable of determining factors that are difficult to estimate through simulation of a practical flight, applying the result to the UAV flight learning model so as to efficiently and accurately perform quality certification by reflecting a situation that can occur during actual UAV operation.

According to an aspect of the present disclosure, there is provided a UAV quality certification system. The system may include: a virtual UAV configuring unit determining information on hardware devices included in a UAV, and configuring a virtual UAV; a UAV simulator performing simulation for the virtual UAV; a UAV flight learning unit controlling learning for a UAV flight learning model that receives the information on hardware devices included in the UAV as an input, and outputs a result of the simulation; and a quality evaluation unit performing quality evaluation on at least one target included in the UAV by using the UAV flight learning model.

According to another aspect of the present disclosure, there is provided a method of performing learning for a UAV flight learning model. The method may include: determining information on hardware devices included in a UAV, configuring a virtual UAV, and performing simulation for the virtual UAV; determining a target on which learning for the UAV flight learning model will be performed; setting an input and an objective parameter for the UAV flight learning model according to the target on which learning will be performed, wherein the input and the objective parameter for the UAV flight learning model are based on the information on hardware devices included in the UAV and a result of the simulation; and performing learning for the UAV flight learning model.

According to still another aspect of the present disclosure, there is provided a UAV quality certification method. The method may include: determining information on hardware devices included in a UAV, configuring a virtual UAV, and performing simulation for the virtual UAV; determining a target of the UAV on which quality evaluation will be performed; setting an input for a UAV flight learning model by using the information on hardware devices included in the UAV on the basis of the target of the UAV on which quality evaluation will be performed; determining a result of the UAV flight learning model; and performing quality certification on the target by using the result of the UAV flight learning model.

According to the present disclosure, there is provided a UAV quality certification system capable of efficiently and accurately performing quality certification for the UAV.

According to the present disclosure, there is provided a UAV quality certification system capable of performing simulation for the UAV by reflecting various environments where the UAB is operated, and performing learning for a UAV flight learning model by using data generated in the simulation.

According to the present disclosure, there is provided a UAV quality certification system capable of determining factors that are difficult to estimate through simulation of a practical flight, applying the result to the UAV flight learning model so as to efficiently and accurately perform quality certification by reflecting a situation that can occur during actual UAV operation.

### BRIEF DESCRIPTION OF THE DRAWINGS

The above and other objects, features, and other advantages of the present invention will be more clearly understood from the following detailed description when taken in conjunction with the accompanying drawings, in which:

FIG. 1 is a view of a block diagram showing a configuration of a system for UAV quality certification according to an embodiment of the present disclosure;

FIG. 2 is a view of an example of operations of performing learning for a UAV flight learning model provided in the UAV quality certification system according to an embodiment of the present disclosure;

FIG. 3 is a view of another example of performing learning for a UAV flight learning model of the UAV quality certification system according to an embodiment of the present disclosure;

FIG. 4 is a view of an example of performing UAV quality evaluation by the UAV quality certification system according to an embodiment of the present disclosure;

FIG. 5 is a view showing an example of an input, an output, and a quality evaluation target of a UAV flight learning model used in the UAV quality certification system according to an embodiment of the present disclosure;

FIG. 6 is a view of an example showing a flowchart of learning method for a UAV flight learning model according to an embodiment of the present disclosure;

FIG. 7 is a view of an example showing a UAV quality certification method according to an embodiment of the present disclosure; and

FIG. 8 is a view of a block diagram showing an example of a computing system performing the UAV quality certification system and method according to an embodiment of the present disclosure.

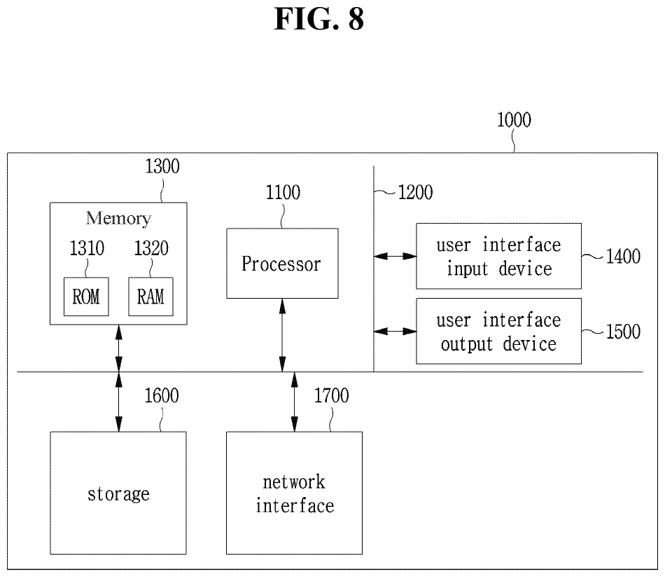

### DETAILED DESCRIPTION OF THE INVENTION

Hereinafter, exemplary embodiments of the present disclosure will be described with reference to the accompanying drawings.

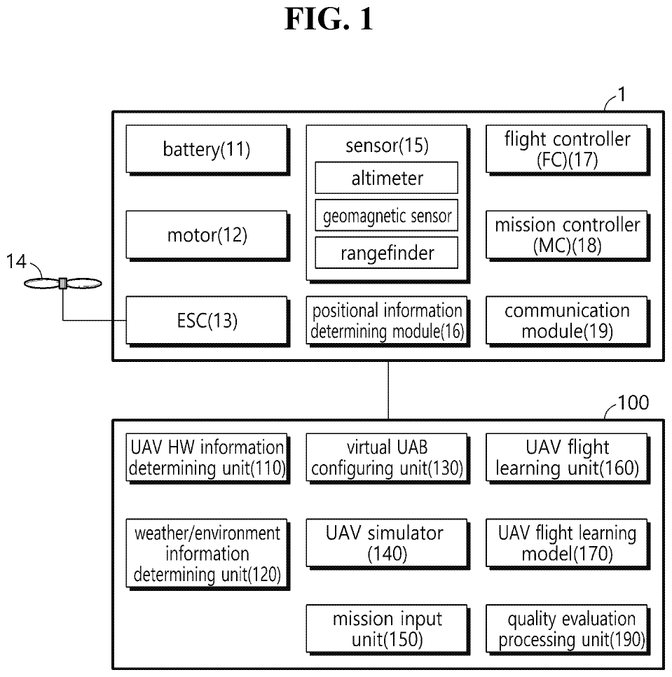

FIG. 1 is a view of a block diagram showing a configuration of a system for UAV quality certification according to an embodiment of the present disclosure.

Referring to FIG. 1, first, a UAV 1 may include a battery 11 such as a secondary battery as a component for providing driving power, and a motor 12, an ESC 13, a propeller 14, etc. as components for generating lift force for a fight of the UAV. In addition, the UAV 1 may include at least one sensor 15 (for example, altimeter, geomagnetic sensor, rangefinder, etc.) for detecting a state of the UAV for a stable flight, and a positional information determining module 16 (for example, GPS, GLONASS, etc.) for detecting a position of the UAV. In addition, the UAV 1 may include a flight controller (FC) 15 controlling a flight of the UAV, a mission controller (MC) 18 for setting a movement path or setting a mission, a communication module 19 performing communication with a GCS, etc.

A UAV quality certification system 100 may provide a simulation environment where the UAV 1 is operated in a virtual environment according to the above-described components of the UAV 1. In detail, the UAV quality certification system 100 may include a UAV HW information determining unit 110, a weather/environment information determining unit 120, a virtual UAB configuring unit 130, a UAV simulator 140, a mission input unit 150, and a UAV flight learning unit 160.

The UAV HW information determining unit 110 may determine information on hardware devices included in the UAV. For example, the UAV HW information determining unit 110 may provide a user interface through which information on hardware devices is input, and store and manage information input through the user interface. Herein, information on hardware devices may include detailed information (specification) on the battery 11, the motor 12, the ESC 13, the propeller 14, the sensor 15, and the positional information determining module 16. Detailed information on the battery 11 may include a manufacturer, a battery capacity, a battery type, etc. Detailed information on the propeller 14 may include a type, a manufacturer, a material, strength, etc. of the propeller.

The weather/environment information determining unit 120 may determine weather information or environment information at a position where the UAV 1 moves, and provide the determined information. The weather/environment information determining unit 120 may be connected to an external server apparatus providing weather information or environment information, determine in real time weather information or environment information by receiving the information from the external server, and provide the determined weather information or environment information. Herein, the weather information may include information on weather, temperature, wind strength, etc.

In another example, weather information or environment information may be changed in various ways, and the weather/environment information determining unit 120 may randomly set the weather information or environment information, and provide the set information.

The virtual UAB configuring unit 130 may fundamentally include a virtual control module (virtual flight controller (FC), mission controller (MC), and communication module) that operates in an algorithm identical to an algorithm of the above-described flight controller 17, mission controller 18, and communication module 19 which are provided in the UAV 1, and configure a virtual UAV by reflecting information on hardware devices provided from the UAV HW information determining unit 110.

The virtual UAV configured as above may be provided to the UAV simulator 140, and the UAV simulator 140 may set a mission input through the mission input unit 150. In addition, the UAV simulator 140 may enable the virtual UAV to be operated in a simulation environment according to a set mission. Herein, the UAV simulator 140 may monitor information associated with hardware devices provided in the UAV while operating the virtual UAV, and store and manage the information.

Further, the UAV simulator 140 may operate the virtual UAV to move according to a mission on a preconfigured map, and control the movement of the virtual UAV by controlling a voltage or current provided to an ESC that is connected to a motor. In addition, the UAV simulator 140 may control the movement of the virtual UAV by reflecting information associated with a sensor or position determining module of the virtual UAV. Herein, the UAV simulator 140 may collect GNSS data for a specific position by being connected to a GNSS signal generator, and manage the collected GNSS data on the map by performing mapping.

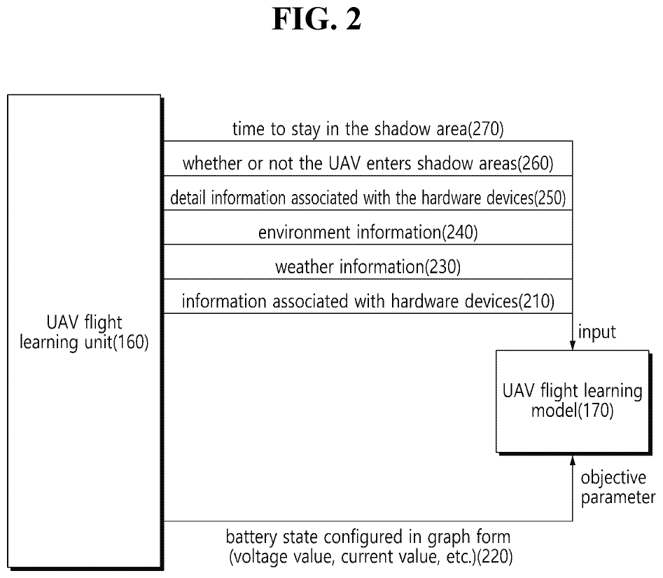

Further, monitored information associated with hardware devices may be provided to the UAV flight learning unit 160. In response thereto, the UAV flight learning unit 160 may perform learning for a UAV flight learning model by using information associated with hardware devices. Learning operations of a UAV flight learning model will be described later in detail with reference to FIG. 2.

FIG. 2 is a view of an example of operations of performing learning for a UAV flight learning model provided in the UAV quality certification system according to an embodiment of the present disclosure.

Referring to FIG. 2, the UAV flight learning unit 160 may set information 210 associated with hardware devices of the virtual UAV configured by the virtual UAB configuring unit 130 as an input of a UAV flight learning model 170. Herein, the information 210 associated with hardware devices may include a battery type, a lifespan of each battery type, etc. In addition, the UAV simulator 140 may detect and store a battery state (voltage value, current value, etc.) every predetermined time unit while performing a flight of the virtual UAV, and configure the detected battery state (voltage value, current value, etc.) as a function of time in a graph form. Then UAV flight learning unit 160 may set the battery state 220 (voltage value, current value, etc.) formed in a graph form as an objective parameter of the UAV flight learning model 170.

Accordingly, learning may be performed for the UAV flight learning model 170 so as to receive a battery type, a lifespan of each battery type, etc. 210 as an input, and output a battery state 220 (voltage value, current value, etc.) configured in a graph form as an output in response to the input.

Meanwhile, how much battery power is consumed over time may be determined through a battery state configured in a graph form. On the basis of the above, a value output from the UAV flight learning model 170 may be used for determining a consumption pattern of the battery. In addition, how much battery power is left may be determined by using a battery state configured in a graph form, and thus a lifespan pattern of the battery may be determined by using a value output from the UAV flight learning model 170.

In another example, weather information or environment information may affect battery consumption during a UAV flight. The UAV flight learning unit 160 may set, in addition to information on hardware devices 210, weather information 230 or environment information 240 as an input of the UAV flight learning model 170.

In another example, various hardware devices provided in the UAV may affect battery consumption, the UAV flight learning unit 160 may determine detailed information 250 associated with the hardware devices such as the motor 12, the ESC 13, the propeller 14, the sensor 15, the positional information determining module 16, etc., and set the determined information as the input of the UAV flight learning model 170 when the UAV simulator 140 performs a virtual flight of the virtual UAV.

In another example, an algorithm determining a position of the UAV may differently operate according to a position of the UAV that is in flight. For example, when the UAV flies in a region without shadow areas, the position of the UAV may be determined through GPS or GLONASS, but when the UAV flies an urban region with shadow areas, an operation of determining positional information may be performed by using information detected through an inertial measurement unit (IMU). Accordingly, since power consumption varies in shadow areas and non-shadow areas, the UAV flight learning unit 160 may set whether or not the UAV enters shadow areas (260) or time to stay in the shadow area (270), etc. as the input of the UAV flight learning model 170.

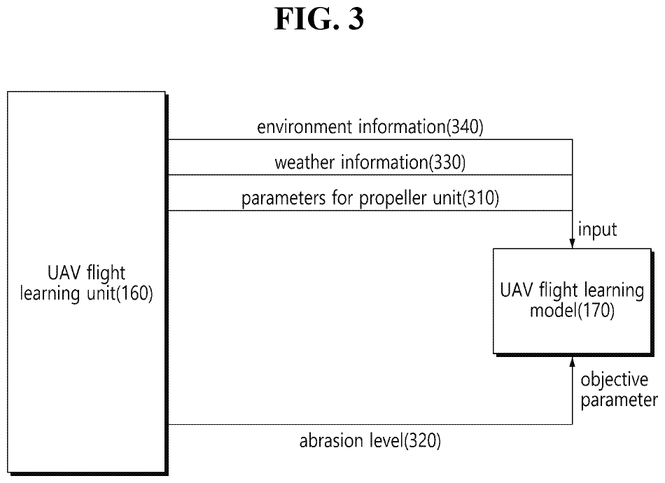

FIG. 3 is a view of another example of performing learning for a UAV flight learning model of the UAV quality certification system according to an embodiment of the present disclosure.

Testing on performance and quality of a propeller device provided in the UAV may be performed by using the UAV quality certification system. For the same, the UAV flight learning unit 160 may perform learning for a parameter of the propeller device through a UAV flight learning model 170. For example, the UAV flight learning unit 160 may set information 310 on a material, thickness, shape, size, mass, etc. of the propeller as an input, and set an abrasion level 320 of the propeller as an objective parameter.

In another example, abrasions due to atmospheric environments, friction in operation by a dynamics model, etc., abrasions due to unexpected collisions, and risk factors such as ionospheric storms and other local wind effects may affect an abrasion level of the propeller. Accordingly, the UAV flight learning unit 160 may set weather information 330 or environment information 340 obtained through the weather/environment information determining unit 120 as an input of a UAV flight learning model 170.

Learning for the UAV flight learning model 170 may be performed by the above-described UAV flight learning unit 160, and the UAV quality certification system may perform UAV quality certification by using the UAV flight learning model 170. Particularly, the UAV quality certification system 100 may further include a quality evaluation processing unit 190 performing UAV quality evaluation.

Hereinafter, with reference to the accompanying drawings, an operation of performing, by the UAV quality certification system, UAV quality evaluation will be described.

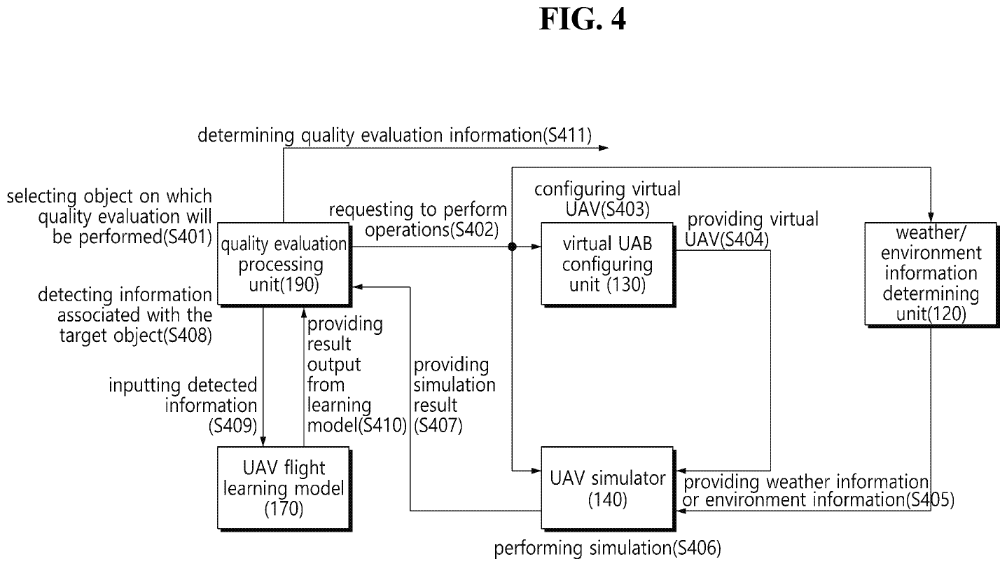

FIG. 4 is a view of an example of performing UAV quality evaluation by the UAV quality certification system according to an embodiment of the present disclosure.

Referring to FIG. 4, in S401, the quality evaluation processing unit 190 may select an object on which quality evaluation will be performed, or receive input of the same. For example, the quality evaluation processing unit 190 may provide a user interface or menu for inputting a target object on which quality evaluation will be performed. For example, a user interface or menu for inputting a target object may provide a list of target objects on which quality evaluation will be performed (for example, a battery, a motor, an ESC, a propeller, a positional information determining module, a sensor, etc.), and configured to enable a user to select or input at least one target object from the provided list.

When at least one target object is selected or input, in S402, the quality evaluation processing unit 190 may request the virtual UAB configuring unit 130, the weather/environment information determining unit 120, and the UAV simulator 140 to perform operations thereof.

In response to the above, in S403, the virtual UAB configuring unit 130 may configure a virtual UAV on which quality evaluation will be performed. For example, as described above, the virtual UAB configuring unit 130 may configure a virtual control module (virtual flight controller, mission controller, and communication module) that operates in an algorithm identical to an algorithm of the above-described flight controller 17, mission controller 18, and communication module 19 which are provided in the UAV 1. In addition, the virtual UAB configuring unit 130 may configure the virtual UAV by reflecting information on hardware devices provided from the UAV HW information determining unit 110. In S404, the resulting virtual UAV may be provided to the UAV simulator 140.

Subsequently, in S405, the weather/environment information determining unit 120 may determine weather information or environment information at a path where the UAV 1 moves, and provide the determined information.

Subsequently, in S406, the UAV simulator 140 may perform simulation for the virtual UAV according to the weather information or environment information. Herein, in S407, the UAV simulator 140 may monitor information associated with hardware devices of the UAV while operating the virtual UAV, and store information determined through the monitoring in a database, or provide to the quality evaluation processing unit 190.

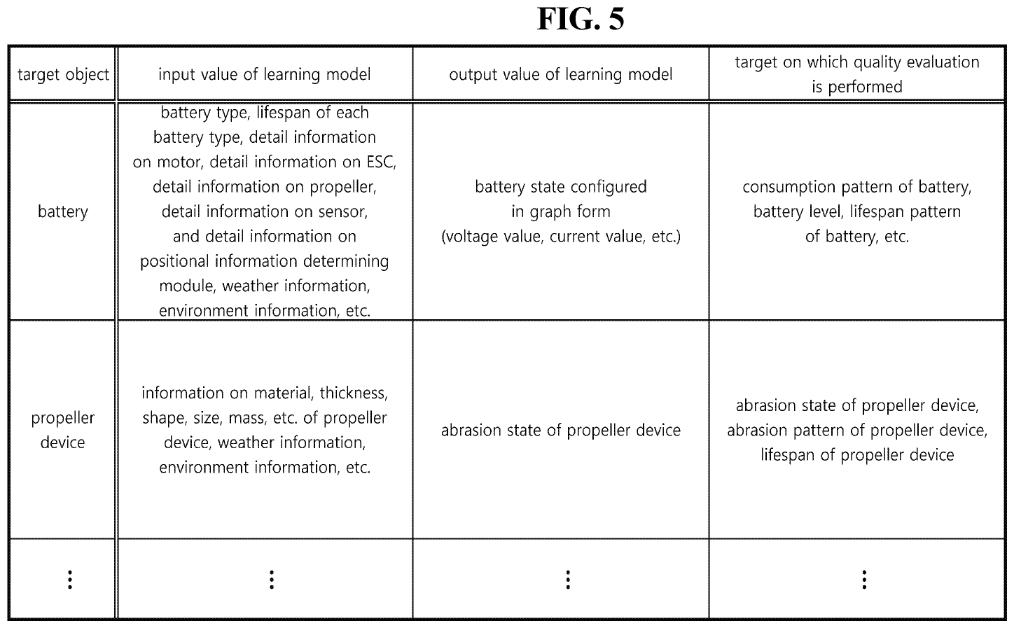

In S408, the quality evaluation processing unit 190 may detect information associated with the target object on which quality evaluation will be performed. Information input to and output from the UAV flight learning model 170 may be differently configured for each target object on which quality evaluation will be performed. For example, as an example shown in FIG. 5, when a target object is a battery, the UAV flight learning model 170 may be a model configured to receive at least one of a battery type, a lifespan of each battery type, detailed information on a motor, detailed information on an ESC, detailed information on a propeller, detailed information on a sensor, and detailed information on a positional information determining module, and to output a battery state (voltage value, current value, etc.) configured in a graph form in response to the received input. In another example, when a target object is a propeller device, the UAV flight learning model 170 may be a model configured to receive information on a material, thickness, shape, size, mass, etc. of the propeller device, weather information or environment information, etc., and to output an abrasion state of the propeller device.

Accordingly, when a target object is a battery, the quality evaluation processing unit 190 may detect information on at least one of a battery type, a lifespan of each battery type, detailed information on a motor, detailed information on an ESC, detailed information on a propeller, detailed information on a sensor, and detailed information on a positional information determining module which are provided in S407.

Subsequently, in S409, the quality evaluation processing unit 190 may input the detected information (for example, a battery type, a lifespan of each battery type, detailed information on a motor, detailed information on an ESC, detailed information on a propeller, detailed information on a sensor, and detailed information on a positional information determining module, etc.) to the UAV flight learning model 170. Subsequently, in S410, the quality evaluation processing unit 190 may determine information (for example, a battery state (voltage value, current value, etc.) configured in a graph form) output from the UAV flight learning model 170.

Further, how much battery is consumed over time may be determined through a battery state configured in a graph form. In S411, on the basis of the above, the quality evaluation processing unit 190 may determine a consumption pattern of the battery by using the battery state configured in a graph form as quality evaluation information. In addition, how much battery power is left may be determined by using the battery state configured in a graph form, and thus the quality evaluation processing unit 190 may determine a lifespan pattern of the battery by using the battery state configured in a graph form, and determine the lifespan pattern of the battery as quality evaluation information.

As describe above, the UAV simulator 140 may manage GNSS data collected through the GNSS signal generator on the map by performing mapping. On the basis of the above, the UAV simulator 140 may determine GNSS data of a region where the virtual UAV is positioned, at the same time, the UAV simulator 140 may determine positional determining information detected by the position determining module of the virtual UAV.

Accordingly, the UAV simulator 140 may determine GNSS data of a region where the virtual UAV is positioned, and position determining information detected by the virtual UAV in S407 so as to provide to the quality evaluation processing unit 190. In addition, the quality evaluation processing unit 190 may perform quality evaluation for the position determining module of the virtual UAV by comparing the GNSS data of a region where the virtual UAV is positioned, and the position determining information detected by the virtual UAV. For example, the quality evaluation processing unit 190 may determine a different value between the GNSS data of a region where the virtual UAV is positioned, and the position determining information detected by the virtual UAV, and when the determined different value between exceeds a preset threshold value, the quality evaluation processing unit 190 may determine that an error has occurred in the position determining module of the virtual UAV.

In another example, the UAV simulator 140 may provide information output from an IMU sensor of the virtual UAV to the quality evaluation processing unit 190, and the quality evaluation processing unit 190 may calculate a relative positional value and a speed value by integrating the information output through the IMU sensor by using an integrator, and determine whether or not an error has occurred in the position determining module of the virtual UAV by comparing the calculated value with a preset threshold value based on the GNSS data of a region where the virtual UAV is positioned.

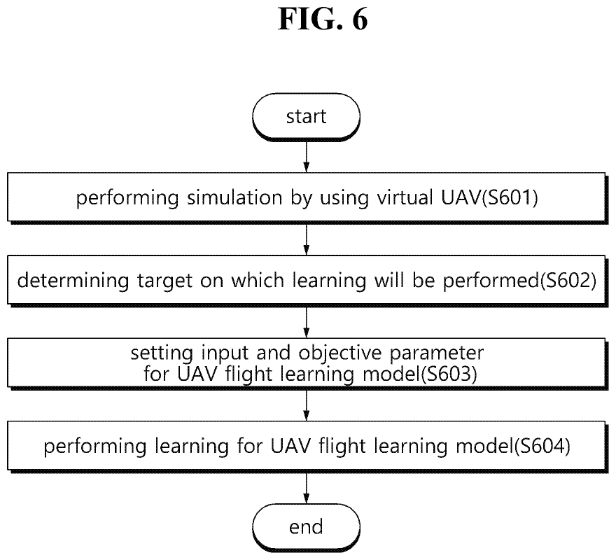

FIG. 6 is a view of an example showing a flowchart of learning method for a UAV flight learning model according to an embodiment of the present disclosure.

A method of performing learning for a UAV flight learning model may be performed by the above-described UAV quality certification system.

In S601, the UAV quality certification system may configure a virtual UAV, and perform simulation by using the configured virtual UAV.

In S602, the UAV quality certification system may determine a target on which learning will be performed. UAV quality certification may be performed for various objects (for example, a battery, a propeller, etc.) provided in the UAV, and the UAV quality certification system may be configured to establish a UAV flight learning model for quality certification. On the basis of the above, the UAV quality certification system may provide a list of targets on which learning will be performed, provide an environment (menu or UI) enabling a user to select at least one target from the provided list, and determine a target on which learning will be performed through the environment. In addition, the UAV quality certification system may detect a UAV flight learning model associated with a target on which learning will be performed.

In S603, the UAV quality certification system may set an input and an objective parameter for the detected UAV flight learning model by using information set in the virtual UAV and the simulation result on the basis of the target selected in S602. Herein, an input for a UAV flight learning model may include information associated with hardware devices which is provided in the virtual UAV, and the information on hardware device may include a battery type, a lifespan for each battery type, etc. In addition, the UAV quality certification system may detect and store a battery state (voltage value, current value, etc.) every predetermined time unit while performing simulation for the UAV, and configure the detected battery state (voltage value, current value, etc.) as a function of time in a graph form. The UAV quality certification system may set the battery state (voltage value, current value, etc.) formed in a graph form as an objective parameter of a UAV flight learning model according to the above output.

In S604, the UAV quality certification system may perform learning for the UAV flight learning model so as to receive a battery type, a lifespan for each battery type, etc. and to output a battery state (voltage value, current value, etc.) configured in a graph form in response to the input.

In S603 and S604, an example is shown where the UAV quality certification system sets an input and an objective parameter for the UAV flight learning model and performs learning by using the set data, but the present disclosure is not limited thereto. Data or information used for an input and an objective parameter for a UAV flight learning model may be changed in various ways. For example, weather information or environment information may affect battery consumption during a UAV flight. According thereto, the UAV quality certification system may set, in addition to information on hardware device, weather information or environment information as an input for a UAV flight learning model.

In another example, various hardware devices provided in the UAV may affect battery consumption, and the UAV quality certification system may determine detailed information of the hardware devices, for example, a motor, an ESC, a propeller, a sensor, a positional information determining module, set the determined information as the input of the UAV flight learning model when performing a virtual flight of the virtual UAV.

In another example, an algorithm determining a position of the UAV may differently operate according to a position of the UAV that is in flight. For example, when the UAV flies in a region without shadow areas, a position of the UAV may be determined through GPS or GNSS such as GLONASS, Beidou, Galileo . . . , but when the UAV flies an urban region with shadow areas, an operation of determining positional information may be performed by using information detected through an inertial measurement unit (IMU). Accordingly, since power consumption varies in shadow areas and non-shadow areas, the UAV quality certification system sets whether or not the UAV enters shadow areas or time to stay in the shadow area, etc. as the input of the UAV flight learning model.

Although, in an embodiment of the present disclosure, the battery is selected as a target in S602, the present disclosure is not limited thereto. A target selected in S602 may be changed in various ways. For example, a target selected in S602 may be a propeller device provided in the UAV.

Hereinafter, an example where data or information is set as an input or an objective parameter for UAV flight learning model when a target selected in S602 is a propeller device provided in the UAV will be described.

In S603, the UAV quality certification system may set information on a material, thickness, shape, size, mass, etc. of the propeller device as an input, and set an abrasion level of the propeller device as an objective parameter.

In another example, abrasions due to atmospheric environments, friction in operation by a dynamics model, etc., abrasions due to unexpected collisions, and risk factors such as ionospheric storms and other local wind effects may affect an abrasion level of the propeller device. Accordingly, the UAV quality certification system may set weather information or environment information as an input of a UAV flight learning model.

On the basis of data or information set on the basis of the above-described process, in S604, the UAV quality certification system may perform learning for a UAV flight learning model.

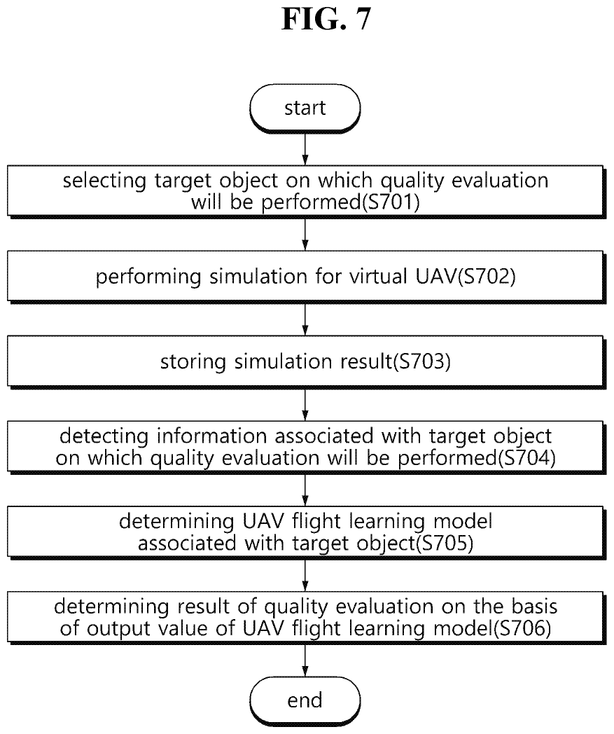

FIG. 7 is a view of an example showing a UAV quality certification method according to an embodiment of the present disclosure.

The UAV quality certification method according to an embodiment of the present disclosure may be performed by the above-described UAV quality certification system.

Referring to FIG. 7, in S701, the UAV quality certification system may receive a selection or input of a target object on which quality evaluation will be performed. For example, the UAV quality certification system may provide a user interface or menu for inputting a target object on which quality evaluation will be performed. For example, a user interface or menu for inputting a target object may provide a list of target objects on which quality evaluation will be performed (for example, a battery, a motor, an ESC, a propeller, a positional information determining module, sensor, etc.), and configured to enable a user to select or input at least one target object from the provided list.

In S702, when at least one target object is selected or input, the UAV quality certification system may configure a virtual UAV, and perform simulation for the configured virtual UAV.

In detail, the UAV quality certification system may configure a virtual UAV for which quality evaluation will be performed. For example, the UAV quality certification system may configure a virtual control module (virtual flight controller, mission controller, and communication module) that operates in an algorithm identical to an algorithm of the above-described flight controller 17, mission controller 18, and communication module 19 which are provided in the UAV. In addition, the UAV quality certification system may configure the virtual UAV by reflecting information on hardware devices. In addition, the UAV quality certification system may determine weather information or environment information at a position where the UAV moves.

Subsequently, the UAV quality certification system may perform simulation for the virtual UAV according to the weather information or environment information. Herein, in S703, the UAV quality certification system may monitor information associated with hardware devices provided in the UAV while operating the virtual UAV, and store the information determined through monitoring in a database.

Subsequently, in S704, the UAV quality certification system may detect information associated with the target object on which quality evaluation will be performed.

The UAV quality certification system may differently configure input and output information for each target object on which quality evaluation will be performed. For example, as an example shown in FIG. 5, when a target object is a battery, the UAV flight learning model may be a model configured to receive at least one of a battery type, a lifespan of each battery type, detailed information on a motor, detailed information on an ESC, detailed information on a propeller, detailed information on a sensor, and detailed information on a positional information determining module, and to output a battery state (voltage value, current value, etc.) configured in a graph form in response to the received input. In another example, when a target object is a propeller device, the UAV flight learning model may be a model configured to receive information on a material, thickness, shape, size, mass, etc. of the propeller device, weather information or environment information, etc., and to output an abrasion state of the propeller device.

Accordingly, when a target object on which quality evaluation will be performed is a battery, the UAV quality certification system may detect information on at least one of a battery type, a lifespan of each battery type, detailed information on a motor, detailed information on an ESC, detailed information on a propeller, detailed information on a sensor, and detailed information on a positional information determining module which are determined and stored in S703.

Subsequently, in S705, the UAV quality certification system may determine a UAV flight learning model associated with the target object on which quality evaluation will be performed. In addition, the UAV quality certification system may input the detected information (for example, a battery type, a lifespan for each battery type, detailed information on a motor, detailed information on an ESC, detailed information on a propeller, detailed information on a sensor, and detailed information on a positional information determining module) to a UAV flight learning model associated with the target object, and determine information (for example, a battery state (voltage value, current value, etc.) configured in a graph form) which is output from the UAV flight learning model.

Further, how much battery power is consumed over time may be determined through a battery state configured in a graph form. On the basis of the above, in S706, the UAV quality certification system may determine a consumption pattern of the battery by using the battery state configured in a graph form as quality evaluation information. In addition, how much battery power is left may be determined by using the battery state configured in a graph form, and the UAV quality certification system may determine a lifespan pattern of the battery by using the battery state configured in a graph form, and determine the lifespan pattern of the battery as quality evaluation information.

Although, in an embodiment of the present disclosure, a UAV quality certification method according to an example where a target object on which quality evaluation will be performed is a battery has been described. The present disclosure is not limited thereto, and a target object on which quality evaluation will be performed may be changed in various ways, and a quality evaluation result may be changed in various ways in response thereto.

According to the above-described UAV quality certification system and method according to an embodiment of the present disclosure, a pattern for each sensor and an amount of power usage can be precisely calculated by using machine-learned data information through calculating the remaining battery power and simulation rather than UAV response situation at the boundary. In addition, an accurate pattern can be detected by using environment information and weather information. In addition, in a practical UAV application, the battery can be used more accurately than before, positional information can be obtained accurately, and returning to an original place can be available. In addition, through the simulation, learning for a UAV flight learning model can be performed, quality evaluation on a device included in the UA can be performed by using the UAV flight learning model, and thus possible risk situations can be detected in advance by performing quality evaluation on the UAV. Further, the learning is performed according to the results of the practical environment, and thus accurate quality evaluation results can be determined.

What is claimed is:

1. A UAV quality certification system, the system comprising:
a virtual UAV configuring unit determining information on hardware devices included in a UAV, and configuring a virtual UAV;
a UAV simulator performing simulation for the virtual UAV;
a UAV flight learning unit controlling learning for a UAV flight learning model that receives the information on hardware devices included in the UAV as an input, and outputs a result of the simulation; and
a quality evaluation unit performing quality evaluation on at least one target included in the UAV by using the UAV flight learning model.

2. The system of claim 1, further comprising: a weather/environment information determining unit determining weather information or environment information at a position where the UAV moves, and providing the determined weather information or environment information to the UAV simulator.

3. The system of claim 2, wherein the information on hardware devices included in the UAV includes at least one of detailed information (specification) of a battery, detailed information on a motor, detailed information on an ESC, detailed information on a propeller device, detailed information on a sensor, and detailed information on a positional information determining module.

4. The system of claim 3, wherein the UAV flight learning unit additionally receives the weather information or environment information as the input of the UAV flight learning model.

5. The system of claim 1, wherein the simulation result includes information a battery state configured in a graph form.

6. The system of claim 2, wherein the UAV flight learning unit sets, as the detailed information on the propeller device, at least one of a material of the propeller device, a thickness of the propeller device, a shape of the propeller device, a size of the propeller device, and a mass of the propeller device as the input of the UAV flight learning model.

7. The system of claim 6, wherein the simulation result includes an abrasion level of the propeller device.

8. The system of claim 2, wherein the quality evaluation unit:
inputs the information on hardware devices included in the UAV to the UAV flight learning model;
determines a result output from the UAV flight learning model; and
performs quality evaluation on the at least one target included in the UAV on the basis of the result output from the UAV flight learning model.

9. The system of claim 8, wherein the quality evaluation unit:
additionally inputs the weather information or environment information to the UAV flight learning model; and
performs quality evaluation on the at least one target included in the UAV on the basis of the result output from the UAV flight learning model.

10. The system of claim 8, wherein the at least one target included in the UAV is a battery or propeller device included in the UAV.

11. The system of claim 1, wherein the UAV simulator collects GNSS data for a specific position by being connected to a GNSS signal generator, and manages the collected GNSS data on a map by performing mapping, and
the quality evaluation unit performs quality evaluation on a positional information determining module on the basis of a difference between accurate position determining information obtained from the positional information determining module included in the UAV, and the result estimated from GNSS data.

12. The system of claim 11, wherein the quality evaluation unit:
determines information output from an IMU sensor included in the UAV as the position determining information; and
performs quality evaluation on the IMU sensor on the basis of the difference between position determining information and the GNSS data.

13. A method of performing learning for a UAV flight learning model, the method comprising:
determining information on hardware devices included in a UAV, configuring a virtual UAV, and performing simulation for the virtual UAV;
determining a target on which learning for a UAV flight learning model will be performed;
setting an input and an objective parameter for the UAV flight learning model according to the target on which learning will be performed, wherein the input and the objective parameter for the UAV flight learning model are based on the information on hardware devices included in the UAV and a result of the simulation; and
performing learning for the UAV flight learning model.

14. The method of claim 13, wherein the performing of the simulation includes:
determining weather information or environment information at a position where the UAV moves; and
performing simulation by reflecting the determined weather information or environment information.

15. The method of claim 14, wherein the information on hardware devices included in the UAV includes at least one of detailed information (specification) of a battery, detailed information on a motor, detailed information on an ESC, detailed information on a propeller device, detailed information on a sensor, and detailed information on a positional information determining module.

16. The method of claim 13, wherein the simulation result used as the objective parameter for the UAV flight learning model includes information on a battery state configured in a graph form or an abrasion level of a propeller device.

17. A UAV quality certification method, the method comprising:
determining information on hardware devices included in a UAV, configuring a virtual UAV, and performing simulation for the virtual UAV;
determining a target of the UAV on which quality evaluation will be performed;
setting an input for a UAV flight learning model by using the information on hardware devices included in the UAV on the basis of the target of the UAV on which quality evaluation will be performed;
determining a result of the UAV flight learning model; and
performing quality certification on the target by using the result of the UAV flight learning model.

18. The method of claim 17, wherein the setting of the input for the UAV flight learning model includes:
additionally setting weather information or environment information as the input for the UAV flight learning model.

19. The method of claim 17, wherein the target is a battery or propeller device included in the UAV.

20. The method of claim 17, wherein in the performing of quality certification on the target, quality evaluation for the target is performed on the basis of a difference between position determining information obtained from an accurate positional information determining module included in the UAV, and the result estimated from GNSS data that prestored for the simulation of the virtual UAV.
